(19) United States
(12) Patent Application Publication
(10) Pub. No.: US 2002/0030132 A1
(43) Pub. Date: Mar. 14, 2002

(54) Balers

(76) Inventor: Brian Haynes, Beaminster (GB)

Correspondence Address: Melvin I. Stoltz, Esq., 51 Cherry Street, Milford, CT, 06460, US

(21) Appl. No.: 09/948,847

(22) Filed: Sep. 7, 2001

(30) Foreign Application Priority Data
Sep. 9, 2000 (GB) 0022118.4

(51) Int. Cl. B02C 1/08; B02C 7/00; B02C 7/12; B02C 13/28; B02C 17/20

(52) U.S. Cl. 241/277

(57) ABSTRACT

A baler for effecting baling of packaging material for recycling purposes includes a chamber into which material to be baled is delivered and within which the material is compacted by means of a pair of endless belts. The material is fed into the chamber by means of a pair of rollers which carry shearing blades for effecting shredding of the packaging material.

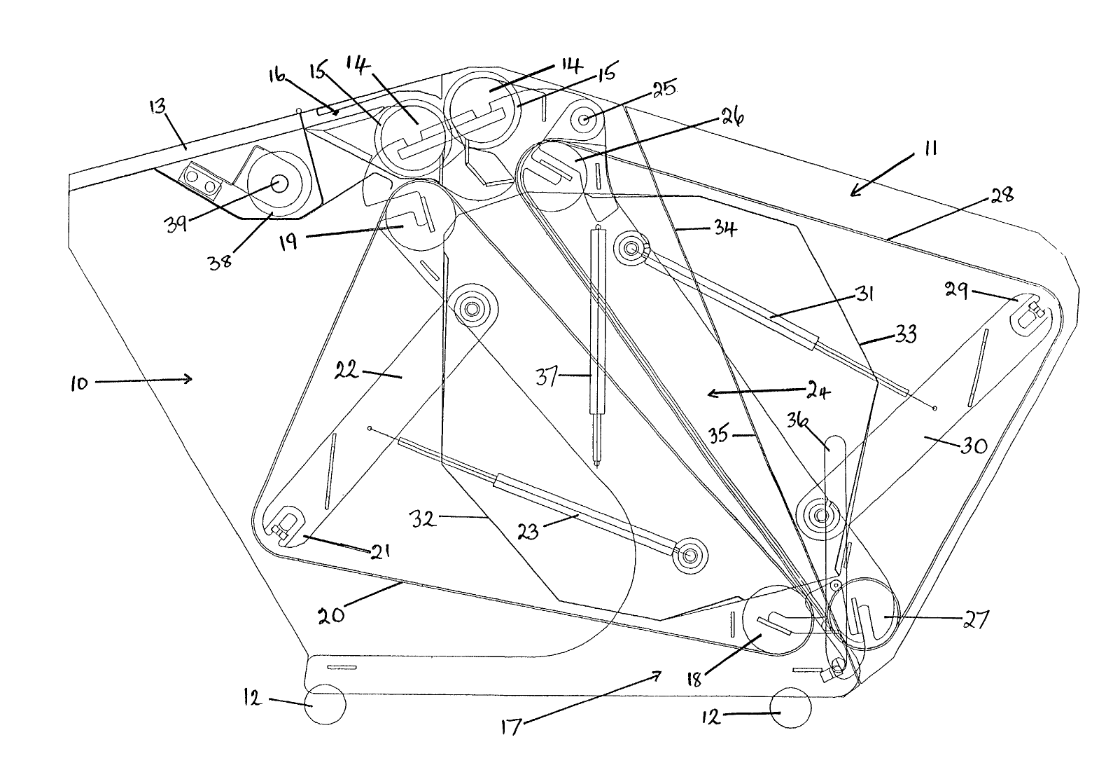

### FIELD OF THE INVENTION

This invention relates to balers, and is particularly concerned with the provision of an improved form of baler for effecting baling of packaging materials, plastic sheeting, cardboard and rags.

Retail outlets have been reluctant to bale packaging materials because of the high cost and unwieldy nature of the balers currently on the market.

It is accordingly an object of the present invention to provide an improved form of baler. It is a more specific object of the present invention to provide a baler for use in a retail outlet for baling packaging material such as cardboard boxes.

### SUMMARY OF THE INVENTION

According to the present invention there is provided a baler which includes a housing containing a chamber into which material to be baled is delivered and within which the material is compacted, an inlet through which the material is supplied and a pair of rollers carrying shearing blades for effecting shredding of the material fed into the inlet so that the material is delivered into the chamber in shredded form.

The shredding rollers are preferably motorised rollers which are arranged so that they rotate about parallel axes and are positioned adjacent a feed table on which material to be shredded, compacted and baled is placed. The rollers are preferably arranged to operate in such manner as to draw any material placed on the feed table into the gap between the rollers and to effect shredding thereof as the material is drawn between the rollers.

The baler chamber preferably contains a pair of rotating endless belt systems for effecting compaction of the material fed into the chamber. The drive for the endless belt systems preferably comprises a pair of drive rollers around which the endless belts are entrained, the endless belts also being entrained over a series of idler rollers.

The baler housing is preferably an all-steel, clamshell fabricated housing with an outer body mounted on a welded box-section frame and castors for facilitating movement of the baler. Some of the castors are preferably locking castors.

A holder carrying a roll of wrapping material is preferably mounted on the baler housing and, in use of the baler, the operator will initiate a wrapping cycle of operations once a predetermined quantity of material has been compacted within the bale chamber. Locking solenoids are preferably provided for maintaining the clamshell housing in its closed condition until wrapping of a bale of compacted material has been effected.

Gas struts or equivalent operating means are preferably provided for opening the clamshell housing once a bale of compacted material has been wrapped, the arrangement being such that a part of the housing containing one of the endless belts is moved into an open position relative to the remainder of the housing to permit discharge of the wrapped bale. One of the idler rollers around which the endless belt in said part of the housing is entrained may be acted on by a gas spring to hold the belt in tension when the clamshell housing is opened to allow the bale to be discharged.

The wrapped bale of compacted material which is formed typically has a diameter of the order of up to 1 meter and a weight of up to approximately 50 kg., the bale being discharged from the baler with its axis horizontal so as to facilitate rolling of the wrapped bale.

The two shredding rollers which carry the shearing blades are preferably arranged to rotate about vertically spaced horizontal axes, one above the level of the presented surface of the feed table and the other below the level of the presented surface of the feed table onto which the material to be shredded, compacted and baled is placed. Each of the rollers preferably carries a plurality of axially spaced shearing blades, with the arrangement such that the shearing blades on one of the rollers are staggered relative to the shearing blades on the other roller.

The design of the shearing blades and the nature of the wrapping material which is used may be such that the wrapping material may be fed between the rollers carrying the shearing blades to effect a wrapping operation. Alternatively, a separate inlet may be provided, adjacent the junction between the two parts of the clamshell housing, for feeding the wrapping material into the baling chamber.

The feed table is preferably positioned at about waist height or just above to facilitate placing of the packaging material on the table.

The invention also provides a method of baling packaging material for recycling purposes which comprises the use of a baler as defined above.

### BRIEF DESCRIPTION OF THE DRAWING

The single FIGURE is a diagrammatic sectional view illustrating the construction and mode of operation of the baler,

### DESCRIPTION OF THE PREFERRED EMBODIMENT

The baler comprises a housing which includes a powder-painted, zinc-coated steel base portion 10 and a cover portion 11 which is also formed of powder-painted zinc-coated steel. The base portion 10 is of rectangular form in plan view and is provided, adjacent its corners, with castor wheels 12 to enable the baler to be moved easily into any desired location.

The upwardly presented part of the base portion 10 includes a feed table 13 onto which cardboard or other sheets of packaging material which are to be shredded are placed. The feed table 13 is located adjacent a pair of shredding rollers 14 which are driven by electric motors (not shown) and each of which carries a plurality of axially spaced shearing blades 15, with the arrangement such that the shearing blades 15 on one of the rollers 14 are staggered relative to the shearing blades 15 on the other roller 14. The cardboard or other sheets pass from the feed table 13 through a passage 16 into the gap between the shredding rollers 14 which are arranged to rotate in opposite directions such that the cardboard sheets are drawn into the gap between the two rollers 14 on rotation of the rollers 14, which thus also act as feed rollers. As will be seen from the drawing, the passage 16 has a narrow mouth which is spaced from the rollers 14 to ensure that the fingers of the operator cannot approach close to the blades of the shredding rollers 14.

The base portion 10 of the baler includes a first steel support structure 17 on which are mounted a drive roller 18 and an idler roller 19. An endless belt 20 is entrained over the two rollers 18 and 19 and over a guide 21 carried by a swing arm 22 which is acted on by a gas-operated tension spring assembly 23 pivotally mounted on the first steel support structure 17 so that the endless belt 20 is urged into the configuration shown in the drawing.

A second steel support structure 24 is mounted on the first steel support structure 17 for pivotal movement relative thereto about a horizontal pivot axis 25. A drive roller 26 and an idler roller 27 are mounted on the second steel support structure 24. An endless belt 28 is entrained over the two rollers 26 and 27 and over a guide 29 carried by a swing arm 30 which is acted on by a gas-operated tension spring assembly 31 pivotally mounted on the second steel support structure 24 so that the endless belt 28 is urged into the configuration shown in the drawing. The two endless belts 20 and 28 are driven in the same direction with the result that the adjacent runs of the two endless belts 20 and 28 are travelling in opposite directions so that any material trapped between the two adjacent runs is subjected to a rolling compacting action.

The baling chamber within the baler is defined by a bottom member 32 attached to the first steel structure 17 and by a top member 33 attached to the second steel structure 24. The arrangement is such that, during operation of the baler to effect shredding and compaction of the cardboard, the components of the baler are in the positions shown in the drawing. An edge 34 of the cover portion 11 rests on an edge 35 of the base portion 10 and the cover portion 11 is held in engagement with the base portion 10 by means of a locking mechanism mounted on a handle 36. The handle 36 is movable into a release position in which the cover portion 11 and the second steel structure 24 are movable, in an anti-clockwise direction as viewed in the drawing, into a position in which the edge 34 of the cover portion 11 is substantially horizontal. The cover portion 11 and the second steel structure 24 are supported in this position by a telescopically extensible stay 37 which is pivotally mounted at its one end on the first steel support structure 17 and is pivotally connected at its other end to the second steel support structure 24.

A roll 38 of shrink-wrap material is mounted on a support roller 39 positioned immediately below the feed table 13 and the arrangement is such that the shrink-wrap material can be withdrawn manually from the roller 39 and then fed through the gap between the two shredding rollers 14. Standard shrink-wrap material can be employed and this is thin enough and flexible enough to be able to pass between the two shredding rollers 14 without being subjected to significant cutting.

In use, cardboard or other packaging material is placed on the feed table 13 and is moved manually so that it enters the passage 16. As soon as the leading end of the packaging material is located between the two shredding rollers 14, it is engaged by the cutting blades 15 and is drawn between the rollers 14 so as to drop into the space between the adjacent runs of the two endless belts 20 and 28. The endless belts 20 and 28 are continuously driven so as to compact the shredded packaging material. Operation of the endless belts 20 and 28 and continued feeding of further shredded material into the space between the two endless belts 20 and 28 will result in the formation of a generally cylindrical mass of compacted shredded material between the adjacent runs of the two endless belts 20 and 28. Operation of the two endless belts 20 and 28 serves to effect rotation of the progressively compacted mass in the baling chamber and outward deflection of the adjacent runs of the two endless belts 20 and 28.

Once a sufficient amount of packaging material has been fed into the baling chamber defined by the bottom member 32 and the top member 33, the feeding of the packaging material into the passage 16 is discontinued and, instead, the leading end of the roll of shrink-wrap material is fed into the passage 16 so as to be engaged between the shredding rollers 14 and fed into the space between the endless belts 20 and 28. The shrink-wrap material is drawn from the support roller 39 and a sufficient length of shrink-wrap material is utilised for it to be wrapped several times around the generally cylindrical mass of shredded and compacted material within the baling chamber. The shrink-wrap material is then cut once wrapping of the generally cylindrical mass within the baling chamber has been completed.

The locking mechanism holding the cover portion 11 and the second steel support structure 24 in their operating positions is then released by means of the handle 36 and the cover portion 11 and the second steel support structure 24 are raised into the position in which the edge 34 of the cover portion 11 is substantially horizontal. This allows the wrapped cylindrical bale of shredded and compacted material to be rolled out of the baling chamber. Once the wrapped bale has been removed, the parts of the baler are returned to their original positions, in readiness for the formation of the next bale.

1. A baler which includes a housing containing a chamber into which material to be baled is delivered and within which the material is compacted, an inlet through which the material is supplied and a pair of rollers carrying shearing blades for effecting shredding of the material fed into the inlet so that the material is delivered into the chamber in shredded form.

2. A baler as claimed in claim 1, in which the shredding rollers are motorised rollers which are arranged so that they rotate about spaced parallel axes such that there is a gap between the rollers, the baler including a feed table on which material to be shredded, compacted and baled is placed and said rollers being located adjacent said feed table.

3. A baler as claimed in claim 2, in which the rollers are arranged to operate in such manner as to draw any material placed on the feed table into the gap between the rollers and to effect shredding thereof as the material is drawn between the rollers.

4. A baler as claimed in claim 1, in which the baler chamber contains a pair of rotating endless belt systems for effecting compaction of the material fed into the chamber.

5. A baler as claimed in claim 4, which includes drive means for the endless belt systems in the form of a pair of drive rollers around which the endless belts are entrained, the endless belts also being entrained over a series of idler rollers.

6. A baler as claimed in claim 1, in which the baler housing is an all-steel, clamshell-shaped fabricated housing with an outer body mounted on a welded box-section frame and castors for facilitating movement of the baler.

7. A baler as claimed in claim 1, in which a holder carrying a roll of wrapping material is mounted on the baler housing such that, in use of the baler, an operator can initiate a wrapping cycle of operations once a predetermined quantity of material has been compacted within the bale chamber.

8. A baler as claimed in claim 7, in which locking solenoids are provided for maintaining the clamshell-shaped housing in its closed condition until wrapping of a bale of compacted material has been effected.

9. A baler as claimed in claim 5, in which gas struts are provided for opening the clamshell-shaped housing once a bale of compacted material has been wrapped, the arrangement being such that a part of the housing containing one of the endless belts is moved into an open position relative to the remainder of the housing to permit discharge of the wrapped bale.

10. A baler as claimed in claim 9, in which one of the idler rollers around which the endless belt in said part of the housing is entrained is acted on by a gas spring to hold the belt in tension when the clamshell housing is opened to allow the bale to be discharged.

11. A baler as claimed in claim 2, in which the two shredding rollers which carry the shearing blades are arranged to rotate about vertically spaced horizontal axes, one above the level of the presented surface of the feed table and the other below the level of the presented surface of the feed table onto which the material to be shredded, compacted and baled is placed, each of the rollers carrying a plurality of axially spaced shearing blades, with the arrangement such that the shearing blades on one of the rollers are staggered relative to the shearing blades on the other roller.

12. A method of produced wrapped bales of shredded packaging material which includes the use of a baler as claimed in claim 7.
